(19) United States
(12) Patent Application Publication
(10) Pub. No.: US 2017/0325440 A1
(43) Pub. Date: Nov. 16, 2017

(54) Hanging Fly and Tool Holder

(71) Applicant: Phillip M. Montano, Littleton, CO (US)

(72) Inventor: Phillip M. Montano, Littleton, CO (US)

(21) Appl. No.: 15/150,750

(22) Filed: May 10, 2016

(51) Int. Cl. A01K 97/06; A45F 5/02

(52) U.S. Cl. CPC A01K 97/06; A45F 5/02

(57) ABSTRACT

A fly fishing holder consists of a central cord (s) upon which is threaded at least one rubber cylindrical hook end holder. A protective hard plastic sheath is threaded inside the rubber cylinder to prevent the hook end of the fly from penetrating the soft (nylon) cord. Plastic platforms can be threaded onto the central cord to provide clips for attaching tools thereto. Various embodiments add a spool shaft, multiple rubber cylinders and spacer washers. The holder allows the fly fisherman to quickly ditch the flies that just aren't working. It provides quick access at your chest to everything the fly fisherman needs like snips, tippet spool, and several flies that cannot fall off as happens with a fly patch.

### FIELD OF INVENTION

The present invention relates to securing fly fishing hooks and fishing tools on a user's clothing for rapid access without opening a container.

### BACKGROUND OF THE INVENTION

Fly fishermen want to quickly change their flies (hooks) when their current flies are not yielding fish. Presently available are foam or fur patches that can hold several flies. These patches do not secure the flies consistently causing the expensive flies to be lost. Other storage items utilize a container that has to be opened and then closed to exchange the fly. This time consuming step causes the fisherman to possibly lose his catch.

One container type holder is the “Tacky Tube” available at www.Caddisflyshop.com. A plastic cylinder is opened into two halves. Each half has a rubber liner with longitudinal recesses. The angler presses the shaft of his fly into a recess so the hook is pointing inward in the cylinder. The hook stays exposed. The disadvantage is the time lost opening and closing the cylindrical case. Also no support for fishing tools or tippet spools is provided.

What is needed in the art is a combination fly, tool and spool holder that hangs on the fisherman's clothes for quick access. The device must firmly and securely hold the flies. The present invention provides a (preferably) rubber cylinder into which the hook end of the fly is inserted through the thin wall. A central cord secures one or more of the rubber cylinders and a plastic accessory platform having clips for tools and a T bracket for a spool.

### SUMMARY OF THE INVENTION

The main aspect of the present invention is to provide a clip on lanyard that has a rubber shell component for securely holding the hook end of a fly.

Another aspect of the present invention is to provide a platform on the lanyard to hold tools.

Another aspect of the present invention is to provide a central hard (plastic) sheath around the lanyard to prevent a hook from penetrating the (nylon) lanyard.

Another aspect of the present invention is to provide a lanyard hook at a top end to enable clipping the fly holder to clothing or any fishing pack.

Another aspect of the present invention is to allow the rubber cylinder to rotate around the lanyard to prevent the fly from falling off when rubbed against.

Other aspects of this invention will appear from the following description and appended claims, reference being made to the accompanying drawings forming a part of this specification wherein like reference characters designate corresponding parts in the several views.

A nylon cord is cut to less than about six inches. A knot at a distal end supports a platform which has clip hooks for tools. The narrow end of a first tapered, hollow rubber cylinder is mounted atop the platform. A hard plastic cylindrical sheath is threaded by the nylon cord inside the rubber cylinder. Thus, a hook end of a fly can be pushed through the rubber cylinder and be shielded from piercing the nylon cord. An alternative design uses a metal cable as a central cord. The rubber cylinder is preferably one to two inches long. A second rubber cylinder can be placed over the distal rubber cylinder. Then a lanyard hook can be glued to the top of the lanyard. A second protective hard plastic cylindrical sheath can be installed inside the upper rubber cylinder. A plastic spacer may separate the upper from the lower rubber cylinder. Alternate embodiments include replacing the lower rubber cylinder with a spool shaft. The nylon cord could be a two strand line to provide a loop at a distal end. Multiple plastic platforms could be threaded onto the cord.

### BRIEF DESCRIPTION OF THE DRAWINGS

FIG. 1 is a front perspective view of a fly fisherman removing a fly from his hanging fly and tool holder.

FIG. 2 is a side perspective view of the fly fisherman casting.

FIG. 3 is a front elevation view of the hanging fly and tool holder loaded with flies and tippet spools.

FIG. 4 is a front elevation view of an alternate embodiment hanging fly and tool holder.

FIG. 5 is a front elevation view of another alternate embodiment of a hanging fly and tool holder.

FIG. 6 is a bottom perspective view of the FIG. 3 embodiment in an empty mode.

Before explaining the disclosed embodiment of the present invention in detail, it is to be understood that the invention is not limited in its application to the details of the particular arrangement shown, since the invention is capable of other embodiments. Also, the terminology used herein is for the purpose of description and not of limitation.

### DETAILED DESCRIPTION OF THE DRAWINGS

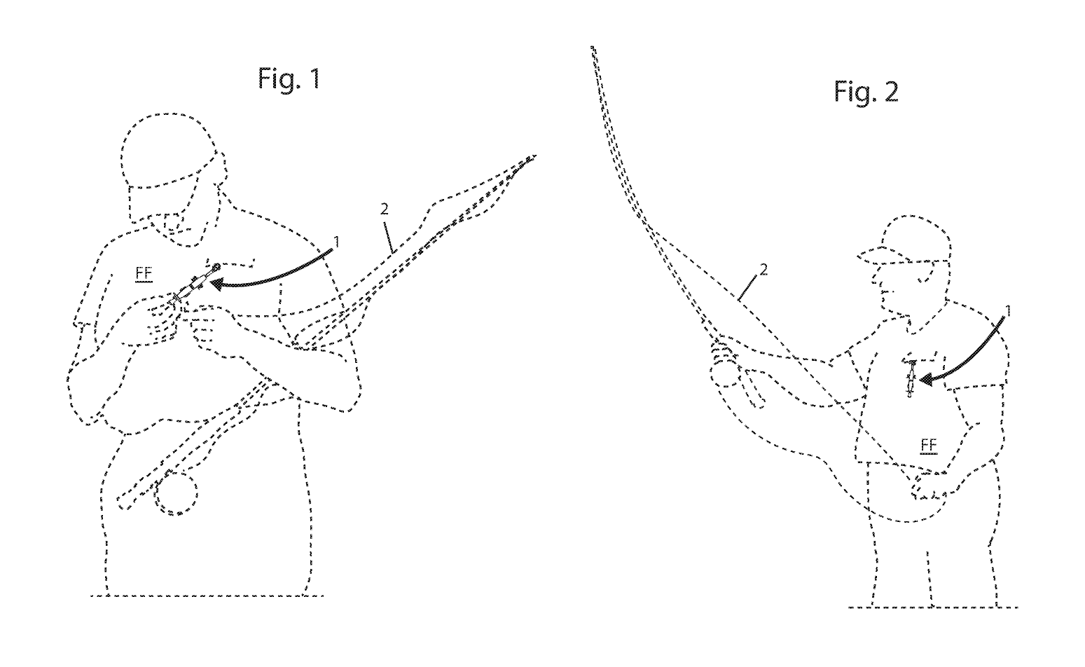

Referring first to FIG. 1 the fly fisherman FF wishes to remove a first fly, hook it into his hanging fly and tool holder 1, then remove a second fly and secure this second fly to his line 2. Time is of the essence here. The prior art methods can take this changing flies operation up to two minutes. The present invention can drop this time to sixty seconds. In FIG. 2 the fly fisherman FF is casting, knowing his valuable flies are secure on his hanging fly and tool holder 1.

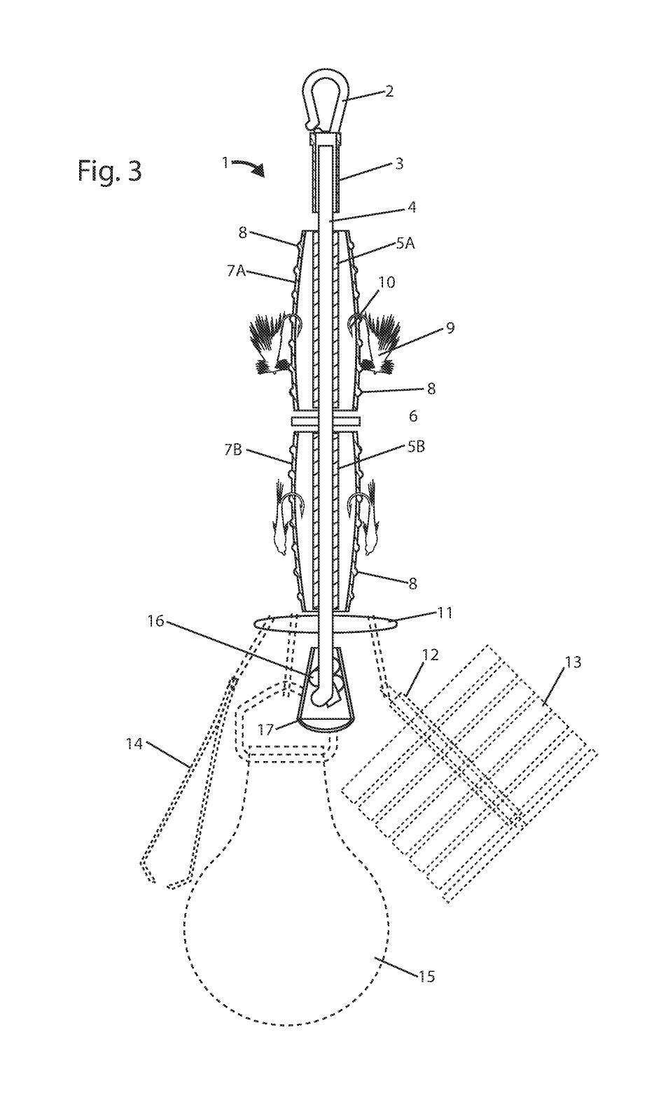

Referring next to FIG. 3 the hanging fly and tool holder 1 has a top clip 2 which can clip onto any convenient part of a garment or backpack. The clip 2 may have a collar 3 that is glued to a (nylon) cord 4. Protective hard plastic tubing segments 5A, 5B are separated by a spacer 6.

Upper hollow cylinder 7A and lower hollow cylinder 7B are preferably thin, hollow rubber cylinders about the thickness and elasticity of a thick rubber band. They rotate to reduce friction. The ribs 8 allow the fly fisherman to quickly pull his fly 9 down the hollow cylinder 7A, 7B and snag the hook 10 on the rib 8 and through the hollow cylinder 7A. The protective hard plastic tube 5A prevents the hook 10 from damaging the (nylon) cord 4.

An accessory loop 11 is threaded onto cord 4 to allow clipping on a tippet holder 12 with tippets 13, nippers 14, a line straightener 15 and so forth. A knot 16 provides a support for the items above it. A plastic bell stopper cord end with a locking lid 17 hides the cord knot 16.

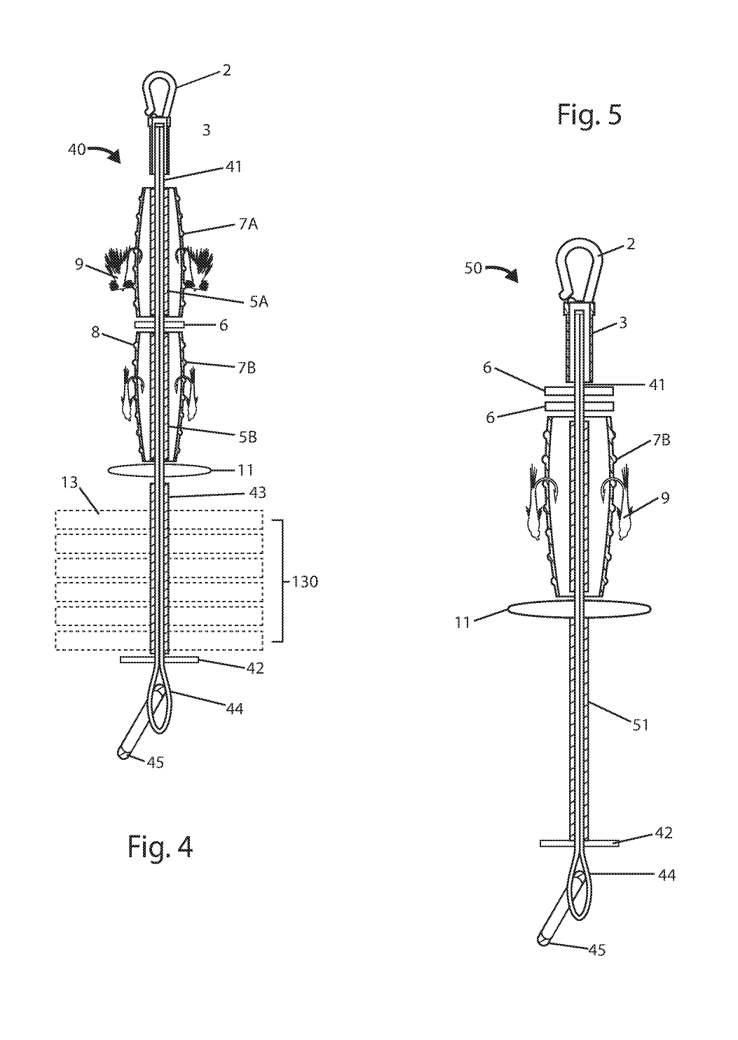

Referring next to FIG. 4 a hanging fly and tool holder 40 has a dual cord 41 glued to collar 3, thus providing a loop 42 at the distal end. A clip 45 is shown clipped to loop 42 for holding more accessories.

Under the accessory loop 11 is a tube 43 which could be made of a hard plastic. This tube 43 serves as a mount for a series 130 of tippets 13. A lower stopper 44 supports the tube 43 atop the loop 42.

Referring next to FIG. 5 a hanging fly and tube holder 50 has only one hollow cylinder 7B for holding flies 9. A lower tube 51 could hold tippets. The loop 42 would be squeezed to thread on tippets after the stopper 44 was removed.

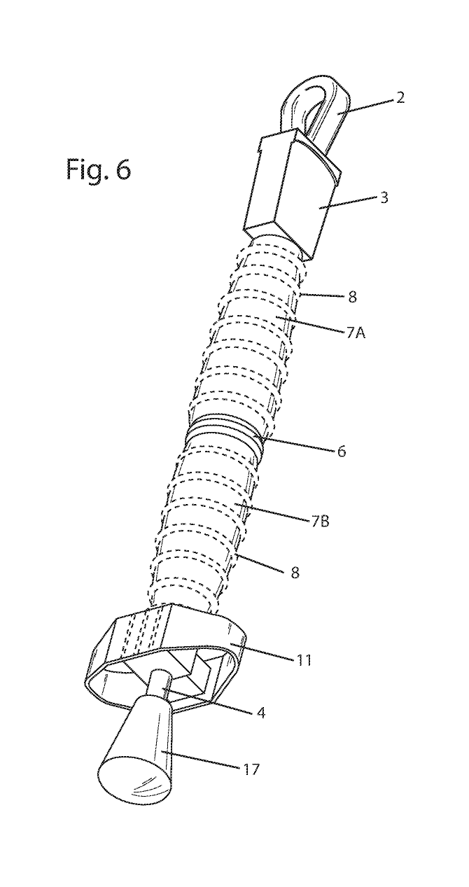

Referring next to FIG. 6 the hanging fly and tool holder 1 is shown empty.

Although the present invention has been described with reference to the disclosed embodiments, numerous modifications and variations can be made and still the result will come within the scope of the invention. No limitation with respect to the specific embodiments disclosed herein is intended or should be inferred. Each apparatus embodiment described herein has numerous equivalents.

I claim:

1. A fly and tool holder comprising:
a central cord having a stop at a distal end;
a tool platform threaded onto the central cord;
a clip attached to the tool platform;
at least one hollow cylindrical hook holder threaded onto the cord;
said hollow cylindrical hook holder comprising a resilient flexible shell which can receive a hook through the shell to hold the hook firmly in place; and
an anchor means at a top of the cord functioning to attach the holder to an object.

2. The holder of claim 1, wherein the central cord is metal to prevent a hook from penetrating it.

3. The holder of claim 1, wherein the central cord is a soft fabric, and a protective sheath is threaded on it to prevent the hook from penetrating it.

4. The holder of claim 3, wherein the hollow cylindrical hook holder further comprises rubber.

5. The holder of claim 4, wherein an exterior surface of the hollow, cylindrical hook holder has a series of ridges to snare a hook engaging the exterior surface.

6. The holder of claim 1 comprising a lower and an upper hollow cylindrical hook holder.

7. The holder of claim 6 wherein each hollow cylindrical hook holder further comprises a taper having a narrow end facing toward an end of the central cord.

8. The holder of claim 7, wherein each hollow cylindrical hook holder further comprises an exterior surface with ridges to engage a hook pushed along the exterior surface.

9. The holder of claim 8, wherein the central cord is a soft fabric and a protective hard sheath is threaded under each hollow cylindrical hook holder.

10. The holder of claim 9, wherein a top of the central cord has a hook.

11. The holder of claim 1 further comprising a spool shaft threaded onto the central cord.

12. The holder of claim 1, wherein the central cord further comprises a pair of cords to provide a loop at an end of the central cord.

13. The holder of claim 1, wherein the hollow cylindrical hook holder further comprises a rotatable mount on the central cord.
